(19) United States
(12) Patent Application Publication
(10) Pub. No.: US 2013/0211873 A1
(43) Pub. Date: Aug. 15, 2013

(54) DETERMINING A CHURN RISK

(71) Applicants: Anand Varadarajan, Chennai (IN); Saravanan Mohan, Chennai (IN); Yeshwanth Vijayakumar, Chennai (IN)

(72) Inventors: Anand Varadarajan, Chennai (IN); Saravanan Mohan, Chennai (IN); Yeshwanth Vijayakumar, Chennai (IN)

(73) Assignee: TELEFOAKTIEBOLAGET LM ERICSSON (publ), Stockholm (SE)

(21) Appl. No.: 13/820,563

(22) PCT Filed: Dec. 10, 2010
(86) PCT No.: PCT/SE10/51357

§ 371 Date: Mar. 4, 2013

(30) Foreign Application Priority Data
Jun. 21, 2010 (IN) 1439/DEL/2010

(51) Int. Cl. G06Q 10/06

(52) U.S. Cl. CPC G06Q 10/0635
USPC 705/7.28

(57) ABSTRACT

An operator's terminal (2) determines a churn risk value associated with a first UE (User Equipment) belonging to a group of operator-connected UEs of a telecommunication system, each UE of the group associated with an initial churn risk value, which depends on the usage. Further, direct weight factors are determined (51) for each direct connection to the first UE, and linked weight factors are determined (52) for each non-direct connection, the weight factors indicating the connectivity between the UEs. Then, the churn risk value is determined (54) based on the initial churn risk values and said weight factors.

### TECHNICAL FIELD

The present invention relates to methods for an operator's terminal of determining a churn risk value associated with a UE of a group of operator-connected UEs. The invention also relates to an operator's terminal configured to determine a churn risk value associated with an operator-connected UE.

### BACKGROUND

A User Equipment, such as e.g. a mobile phone, has to be connected to an operator/service provider in order to access a telecommunication network, and the operator charges the owner of the UE, i.e. the end-user/subscriber, for the service.

However, the end-user may decide to churn, i.e. end his subscription and switch to another operator, e.g. if he/she is not satisfied with the service, or if another operator is offering a lower price or a better service.

A churn prediction is an attempt to determine the probability that an end-user (and the UE belonging to the end-user) will leave the operator/service provider. This information may be used by an operator e.g. for targeting marketing activities to an end-user with a comparatively high probability to churn-out, in order to prevent him/her to end the subscription.

In a telecommunication network, a conventional churn prediction technique may be based e.g. on analyzing the call rate from a User Equipment, since a decreased call rate may be an indication that the end-user, and the User Equipment associated with the end-user, is a potential churner. Information associated with an end-user may be retrieved from a Call Detail Record (CDR), which contains details e.g. regarding voice calls and SMS. A drawback with this technique is that a potential churner may be identified too late, e.g. when he/she has already switched to another operator.

Other related art within this technical field is disclosed e.g. in Dasgupta et. al: “Social Ties and their Relevance to Churn in Mobile telecom Networks”, IBM India Research Lab, describing a study of the communication pattern of a large number of mobile phone-users in an operator's network, and the social networks formed between the users. The article further describes an analysis of how the probability that a user will churn-out from the network depends on the number of “social ties”, i.e. friends, to the end-user that has already switched to another operator. Based on the analysis, the article describes a method predicting potential churners by examining current churners and their social network.

Further related art is described e.g. in WO 2010/050863, disclosing a method of preventing customer churning, by determining a service offer to the customer, creating a behavioral model based on a churned-out customers behavior, and creating a customer model corresponding to a potential churner. Based on this, one or more variants are created for minimizing the churn risk of a customer, and the service offer is updated according to the variants.

### SUMMARY

An object of the invention is to address at least some of the issues outlined above, and this object and others are achieved by the method and the apparatus according to the appended independent claims, and by the embodiments according to the dependent claims.

According to a first aspect, a method is provided for an operator's terminal in a telecommunication network of determining a churn risk value associated with a first UE (User Equipment) belonging to a group of operator-connected UEs. Each UE of the group is associated with a pre-calculated initial churn risk value, which depends on the usage. The method comprises determining a direct weight factor for direct connections between the first UE and other UEs of the group, and a linked weight factor for non-direct connections between the first UE and other UEs of the group, based on the direct weight factors of the connection. Further, the method comprises calculating a weighted churn value for each of said direct and non-direct connections to the first UE from the other UEs of the group, based on each determined weight factor and the initial churn risk value associated with the corresponding other UE, and finally determining a churn risk value for the first UE by adding each calculated weighted churn risk value to the initial churn risk value associated with the first UE.

According to a second aspect, an operator's terminal is provided that is connectable to a telecommunication network, the terminal comprising a data collecting unit and a data analyzing unit. Each of those units is provided with a processing unit, and the terminal is configured to determine a churn risk value associated with a first UE by determining a direct weight factor for direct connections between the first UE and other UEs belonging to a group of operator-connected UEs, and a linked weight factor for non-direct connections between said first UE and the other UEs of the group, based on the determined direct weight factors of the connection. The terminal is further configured to calculate a weighted churn value for each of said direct and non-direct connections to said first UE, based on each determined weight factor and a pre-calculated initial churn risk value associated with the corresponding other UE, based on the usage, and to determine a churn risk value for the first UE by adding each calculated weighted churn risk value to the initial churn risk value associated with the first UE.

An advantage with exemplary embodiments is that a potential churner may be identified earlier, by taking into account the influence from other end-user in a social network.

### BRIEF DESCRIPTION OF THE DRAWINGS

The present invention will be described in more detail below, and with reference to the accompanying figure, of which:

FIG. 1 is a block diagram illustrating two groups of User Equipments, and the communication links within each group;

FIG. 2 is a block diagram illustrating a group of User Equipments, and exemplary values indicating the churn risk and the connectivity;

FIG. 3 is a block diagram schematically illustrating an exemplary initial churn risk value determination;

FIG. 4 is a block diagram schematically illustrating an exemplary architecture of functional layers;

FIG. 5 is a flow diagram schematically illustrating an exemplary method for an operator's terminal of determining a churn risk value;

FIG. 6 is a flow diagram schematically illustrating an exemplary method for an operator's terminal of determining an initial churn risk value for UE, and

FIG. 7 is a block diagram schematically illustrating an exemplary operator's terminal.

### DETAILED DESCRIPTION

In the following, the invention will be described in more detail with reference to certain embodiments and to an accompanying drawing. For the purpose of explanation and not limitation, specific details are set forth, such as particular scenarios, techniques, etc., in order to provide a thorough understanding of the present invention. However, it is apparent to one skilled in the art that the present invention may be practiced in other embodiments that depart from these specific details.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as in a system comprising a computer processor and a memory coupled to the processor, wherein the memory is encoded with one or more programs that may perform the functions disclosed herein.

The embodiments described hereinafter implements a churn prediction technique, which incorporates a so-called community effect of churning, i.e. the concept that a churn risk for an end-user is influenced by the behaviour of other users to which the end-user is connected.

Due to the community effect of churning, the churn risk for an end-user/subscriber may not be determined only from his/her own activities, but also based on the effect from other end-users to which the he/her is connected, i.e. his/her social network. Thus, the determination of a churn risk for an end-user may also take into account the influence from a social network of the end-user.

However, the community effect of churning may be difficult to calculate, due to the large amount of data that is required in order to take into account the influence of the behavior of other end-users belonging to the same social network, i.e. group of end-users.

Evolutionary techniques may be incorporated in order to derive classification rules for determining the behavior of end-users, and a game theoretic approach may be used for understanding the community effect in a group, wherein the grouping of operator-connected end-users may be based on usage and location.

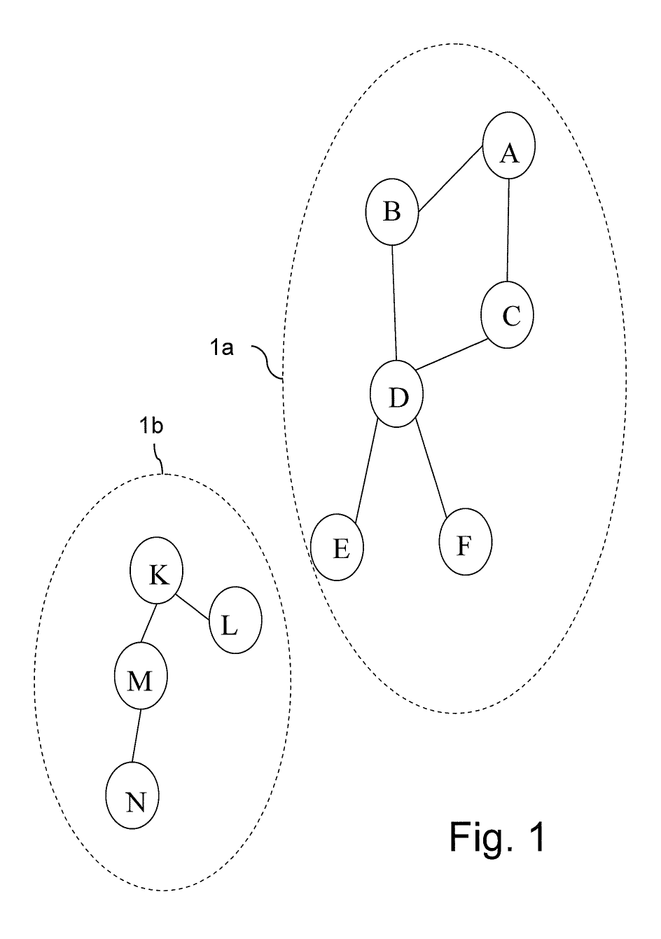

FIG. 1 illustrates schematically two groups 1a, 1b, of end-users, which may be referred to as “social networks”, the end-users of a group being subscribers to the services of the same operator. The first group 1a comprises six end-users of UEs (User Equipments) in a telecommunication network, and the second group 1b comprises four end-users/UEs. In reality, the number of users in a group would typically be much larger, but FIG. 1 only aims to explain the concept of a group, according to this invention, and the connections/links between the users of a group. In the first group, the user A has a direct connection (or link) to the users B and C, and a non-direct connection (link) to user D, user E and to user F. The user D is one “hop” away from user A, and the user E and user F are both two “hops” away from user A, wherein one “hop” would correspond to an additional connection/link. Similarly, in the second group 1b, the user N has a direct connection to the user M, and non-direct connections to the user K and to the user L, the user K being one “hop” away from user N, and the user L being two “hops” away from user N.

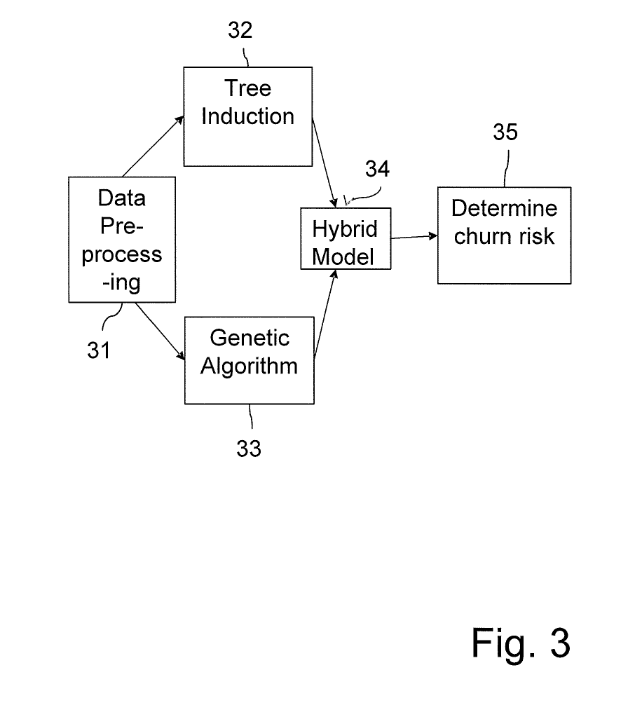

An exemplary embodiment for determining the churn risk of a user employs a so-called evolutionary hybrid model, which is illustrated in FIG. 3, and comprises data preprocessing 31, rule generation, e.g. using a tree induction technique 32 or a genetic algorithm 33, followed by a classification 34 of the user based on the generated rules, and a churn risk determination 35, which is based on the community effect of the churn.

Regarding the above-mentioned data pre-processing, records are typically generated and stored in a charging system of a mobile operator for every operation performed by a customer, and these records are conventionally referred to as Call Detail Records (CDR) of the charging system. Normally, the CDRs are available from the repository of a mobile operator for a period of two months, and customer data may be extracted and analyzed from the CDR, in order to illustrate the behavior of a customer.

In the data pre-processing, according to an exemplary embodiment, the required fields of the CDR are split and aggregated over specific time intervals, and possible churners are identified. The length of the time intervals could be flexible, such that if data for one month is available, the month may be split e.g. into three intervals. If a user has not made any call in the last interval, he/she may be classified as a possible churner, since he/she has stopped using the services offered by the operator in the last recorded days. On the contrary, if a user has joined the operator in the end of month, the number of calls made by him/her in the first two intervals will be zero, but the user will not be classified as a possible churner.

The rule generation may use e.g. a tree induction techniques and a genetic algorithm, as illustrated in FIG. 3.

With reference to the tree induction technique, a decision tree is commonly used in order to gain information for the purpose of decision-making. A decision tree starts with a root, where a user decides to take an action. From the root, the decisions of the user is split recursively, according to a decision tree learning algorithm, wherein the result is a decision tree, in which each branch represents a possible scenario of decision, and its outcome. The tree induction technique may be used because the output format is easy to interpret as if-then statements.

With reference to the above-mentioned genetic algorithm, genetic programming (GP) is a specialization of a genetic algorithm, and it may be described as an evolutionary algorithm-based method inspired by biological evolution for finding a computer program that performs a user-defined task. More specifically, it is a machine-learning technique, which could be used to optimize a computer program according to a fitness landscape determined by a program's ability to perform the user-defined task.

The main operations that may be used in evolutionary algorithms, such as e.g. in genetic programming, are crossover and mutation. Crossover is applied on an individual by simply exchanging one “node” representing the individual with another node representing another individual in the population. With a tree-based representation, replacing a node means replacing a whole branch. Mutation affects an individual in the population, and it may replace a node representing a selected individual, or it may replace only the information of the node. In order to be secure and preserve the integrity, the operations should be able to e.g. handle binary operation nodes and missing values.

Unlike some other algorithms, a genetic algorithm will not get stuck in a local maxima or minima, and it will provide a constant accuracy rate on similar data.

When more than one data processing model/technique is used, it may be determined which one of the output results that should be used, and the applicability of the result. Both the above-described tree induction technique, as well as the genetic programming technique will result in an output indicating whether a person can be classified as a possible churner or not. According to an exemplary embodiment, the outputs from two techniques are combined using a hybrid model, taking the accuracy of each technique into account, such that the combined result is calculated by multiplying each output with the accuracy of the technique, and calculating the average value of two resulting values. Typically, the output from a hybrid model will deviate towards output from the data processing model/technique with the higher accuracy.

According to an exemplary embodiment, the resulting output value will be used as an initial churn risk value in the determination of the churn risk value of a user. Further, according to embodiments of the invention, the determination of the churn risk for an end-user is based on the behavior of the other end-users in a social network of the end-user. If a churned-out end-user is strongly connected to other end-users in a group (social network), then the churn propagation from the churned-out end-user to the strongly connected other end-users will be high. In order to determine a churn risk value for an end-user, based on the above initial churn risk value and the churn propagation from other end-users in a group, a game theoretic approach may be used, considering the connectivity, i.e. the strength (weight) of a connection, between the end-users in a group of operator-connected users.

In order to consider the connectivity, the weight of a connection between two UEs is determined as a function of the call rate, the SMS/MMS rate, and the duration of the calls, and any other suitable parameter indicating the strength of the connection. The determined weight is bi-directional.

Further, based on the bi-directional connectivity between the UE/end-user, for which the churn risk is determined, and another UE/end-user, as well as the initial churn risk value for said another UE/end-user, a weighted churn risk value is determined for each connection to the UE/end-user from the other UEs/end-users of the group, according to embodiments of the invention. Since the weight of a connection indicates the connectivity between two UEs, it is also a measure of the churn propagation from another UE to the UE for which the churn risk is determined.

Thus, in order to determine the churn risk value for a first UE, of a group of operator-connected UEs, the weight of each connection between this first UE and the other UEs of the group is determined. Thereafter, the product of the weight of each connection and the initial churn value for the other UE is determined, and a churn risk value for said first UE is calculated, based on the sum of said products, added to the initial churn risk value for the first UE.

Further, while the weight of a direct connection between another UE and the first UE is determined as a direct weight factor, based on the call rate, SMS rate and duration of the calls, the weight of the non-direct connections between the first UE and other UEs in the group is determined as a linked weight factor, based on the direct weight factors of the connections included in the non-direct connection.

By automatically iterating the calculation for each observation time interval, a determined churn risk value may be updated continuously. According to an exemplary embodiment, for each iteration, the initial churn risk value for the first UE is set to the churn risk value determined in a previous iteration.

According to another exemplary embodiment, the churn risk value is determined with operator-defined time intervals, which typically are longer than the above-mentioned observation time intervals, with the initial churn risk values re-calculated at each iteration. Further, the re-calculated initial churn risk value is compared with a previous initial churn risk value, and the determined churn risk value is adjusted, based on the comparison. According to an exemplary embodiment, if the re-calculated initial churn risk value is much lower than the previous initial churn risk value, the determined churn risk value is determined as an average of the determined churn risk value and the previously determined churn risk value. On the contrary, if the present initial churn risk value is much higher than the previously determined initial churn risk value, the corresponding end-user may be identified as a potential churner. However, if the re-calculated initial churn risk value basically corresponds to the previously determined initial churn risk value, then the determined churn risk value will not adjusted.

A linked weight factor for a non-direct connection between a first UE and another UE is determined based on the direct weight factors determined for the direct connections included in the non-direct connection. According to an exemplary embodiment, the linked weight factor is determined by calculating a sum of the direct weight factors for each direct connection with said another UE, and calculating the average value of the direct weight factors for each connection between the UEs that is directly connected to said another UE and the first UE. Further, a sum of the calculated average values is determined, and said calculated sum of the direct weight factors is divided by said sum of the calculated average values, in order to obtain a linked weight factor.

An advantage with embodiments described herein is to provide a churn risk determination that is accurate, and is able to take into account the influence from the “neighboring” end-users, based on the connectivity between them.

The embodiments according to the invention differ from the solution as described in the article by Dasgupta et. al., cited in the Background section, e.g. in that the churn risk for an end-user is determined based on his/her own behavior, as well as the churn propagation from other end-users in a group of operator-connected UEs instead of determining of the churn risk based on the number of friends in a social network that has already churned-out.

Another advantage with exemplary embodiments of the invention is that they do not require any data associated with previously churned-out end-users, since they depend on an analysis of the usage profile in order to determine an initial churn risk. Further, the changes of the churners and their friends do not have to be tracked over a period. Instead, the determining of the churn propagation involves assigning an initial churn risk value to each user, depending on his/her usage.

Also, the embodiments determine the churn propagation in the direction from the neighboring UE to the UE for which a churn risk is determined, instead of considering the opposite direction, i.e. from a churner to the neighbors.

Further, the exemplary embodiments are applicable to an entire set of end-users, not only a subset, and other exemplary embodiments of this invention are iterative, and also considers positive influences, not only negative influences. For example, when a person do not make any calls during a period, e.g. because of a journey, the solution according to the article by Dasgupta et. al would either classify him/her as a churner, or not catch the low usage at all. Thus, according to embodiments of the invention, the number of false positives will be very low, due to the calculation over different time periods, since the churn risk is calculated automatically for each of the iterations. It is also computationally efficient, since a split-aggregated data pre-processing may be used for obtaining an initial churn risk depending on the usage, in order to provide an input for determining the churn propagation.

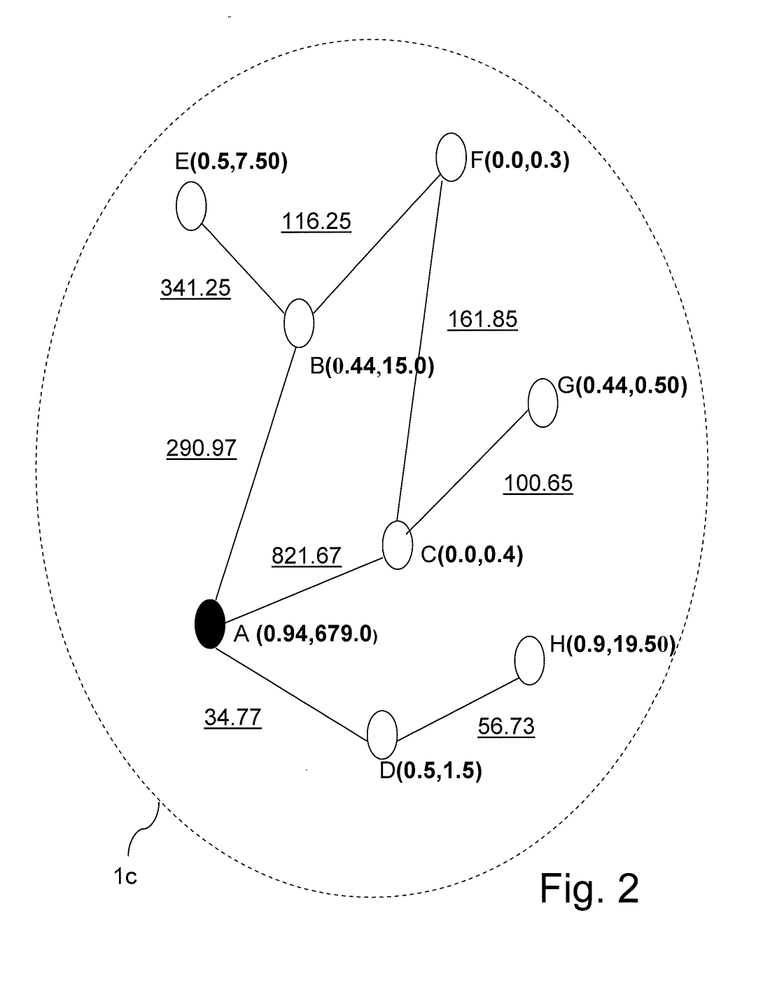

According to a practical determination of a churn risk, implemented according to an exemplary embodiment of this invention, a not-normalized determination for 150,000 subscribers resulted in an average churn risk value of 0.39185 and a maximum of 679, of which a subgroup of the 150,000 subscribers are illustrated in FIG. 2. These values are absolute values representing how likely a subscriber is to churn, compared to another subscriber in the same group.

Thus, FIG. 2 illustrates exemplary churn risk values for only a subgroup of the 150,000 subscribers, further indicating churn propagation between a set of UEs indicated by A to H, the churn propagation corresponding to the strength of the connectivity, which is indicated by the exemplary underlined values at each link. The values in the brackets denote an exemplary initial churn risk value and an exemplary final churn risk value, after taking the churn propagation, i.e. the connectivity, into account. According to the exemplary user A, the initial churn risk value is 0.94, but the final value is as high 679.0, due e.g. to a comparatively strong connectivity between the user A and other users in the group.

A churn risk determination as described herein is applicable by the operator e.g. for management and marketing purposes, for monitoring and tracking service performance, for visualizing customer behavior in order to target advertisements and launch new services, and providing online product recommendation to other applications and/or 3GPP-service/content/advertisers providers.

The system architecture may comprise different functional layers in order to collect data, to extract and transform the collected data, to perform data mining algorithms, and to visualize the results. Further, service delivery API's may provide external access to the data collection, data processing, and the data mining activities, as well as to the results.

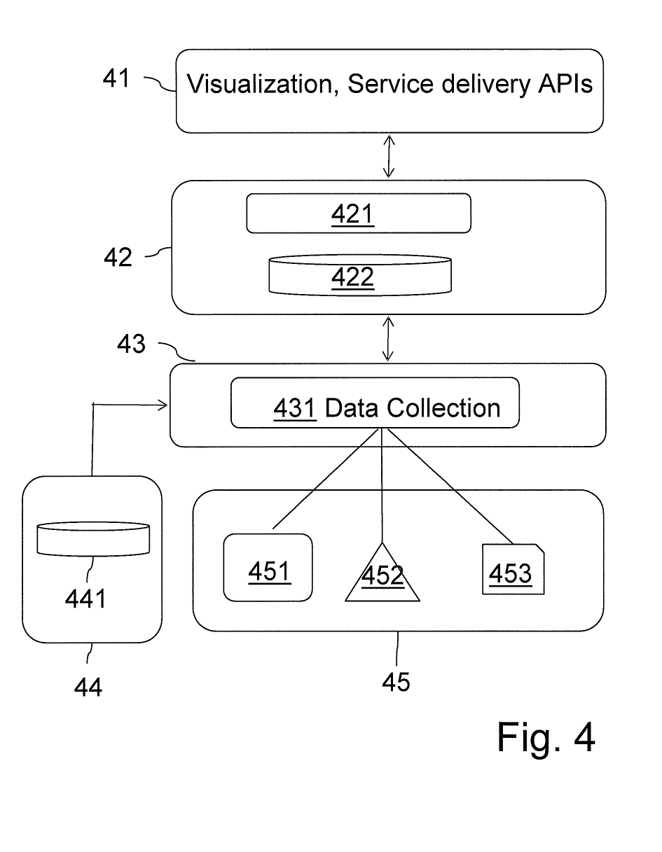

FIG. 4 schematically illustrates an exemplary architecture of the different functional layers for embodiments described herein, such as the Visualization and Service delivery API's layer 41 for supporting presentation of knowledge in order to assist domain experts to interpret information, and to examine and modify the mining rules and mining algorithms. Said service delivery APIs are published to external systems and/or experts subscribing to services, and the services may involve to initiate the collection, processing and data mining activities, and to obtain results externally. The Knowledge, Exploration and Discovery-layer 42 supports e.g. data mining algorithms and selects appropriate algorithms, and comprises an Algorithm Rule Engine and Validation-functionality 421, as well as data mining marts 422. Further, the Collection-layer 43 supports a collection of customer-data from different sources, e.g. regarding customer usage, the layer comprising a Data Collection-functionality 431 collecting data from operator data sources 44, including data servers 441, as well as from local data mining 451, from users/nodes 452 and from log files 453.

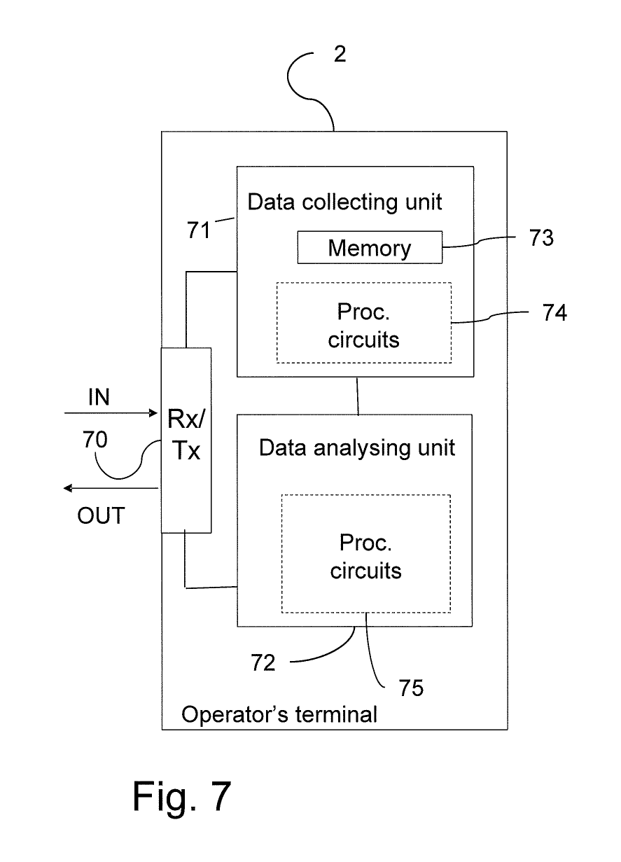

The functionally layers illustrated by boxes 42 and 43 in this figure may be located in an operator's terminal, according to embodiments described herein, and as illustrated in FIG. 7, which is described below.

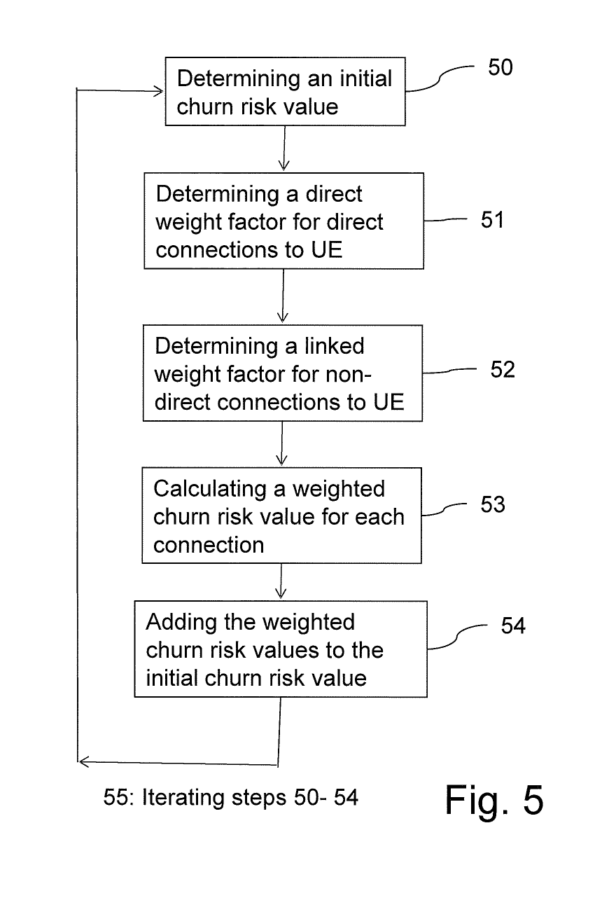

FIG. 5 is a flow diagram schematically illustrating an exemplary method for an operator's terminal of determining a churn risk value for a first UE of a group. First, a pre-calculated initial churn risk value is used as input 50 for churn risk determination, and in step 51 a direct weight factor is determined for the direct connections between the first UE (for which the churn risk is determined) and other UEs in a group of operator-connected UEs. The weight factor is a measure of the connectivity between the end-users of the UEs, i.e. the strength of the connectivity, and it is typically determined as a function of one or more weight factor parameters, such as e.g. the call rate, the SMS/MMS rate, as well as the duration of the calls. The linked weight factors for the non-direct connections between said first UE and the UEs of the group being one or more hops away from the first UE is determined in step 52, based on the direct weight factors of the direct connections included in the non-direct connection.

Further, in step 53, a weighted churn risk value is determined for each connection with the first UE, based on the weight factor, and the churn risk value of the other UE of the connection, typically as the product of the weight factor and the initial churn risk value of the corresponding other UE. Finally, in step 54, the churn risk value for the first UE is determined by adding a sum of the weighted churn risk values for each connection with the first UE, to the initial churn risk value for said first UE.

According to a further embodiment, the steps 50-54 are iterated automatically, in step 55, in order to regularly obtain an updated churn risk value for every time period of observation, and the initial churn risk value, in step 50, is determined by setting it to correspond to the churn risk value determined in step 54.

According to an exemplary embodiment, the steps 50-54 are further iterated at operator-defined intervals, with the initial churn risk value, in step 50, being determined by a re-calculation for each iteration, the re-calculated initial churn risk value for the first UE being compared with a previous initial churn risk value, and a determined churn risk value adjusted based on the comparison.

Preferably, the method is performed for several, or all, of the UEs in a group of operator-connected UEs, the grouping of UEs being based on the interaction between them.

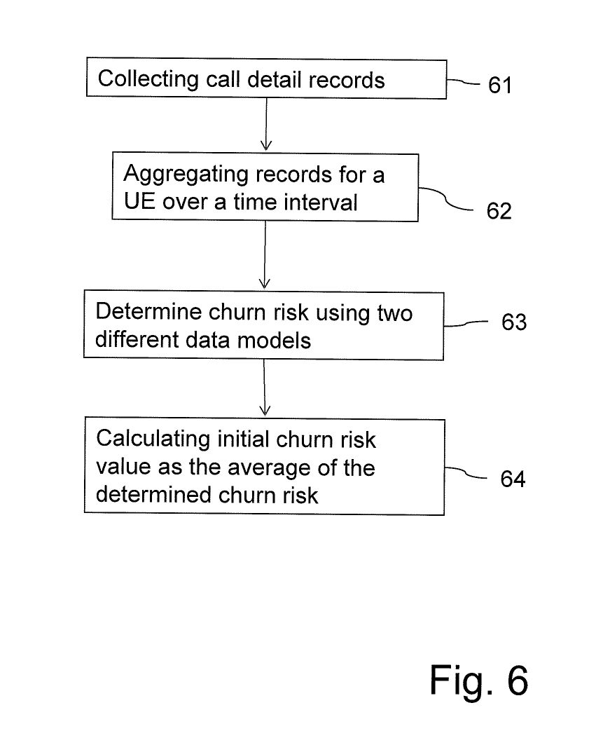

FIG. 6 is a flow diagram schematically illustrating an exemplary method for an operator's terminal of determining an initial churn risk value for an UE, and comprises, in step 61, a conventional collection and generation of call detail records, which are to be used e.g. by the charging system. However, according to this exemplary method, the records are split and aggregated over a suitable time interval, in step 62, and the UE is classified as a possible churner or not using at two different data processing models, in step 63. The data processing models are typically a tree induction technique and a genetic algorithm. Thereafter, in step 64, an initial churn risk for an end-user of the UE is calculated, based on the output from the two different data models, typically as an average of the two outputs, also based on the accuracy of each of the data models.

Thus, the embodiments described herein implements a churn risk determination that may be depended upon for prediction accuracy, as well as for taking into account the social influence of neighbors, by virtue of the strength of the connections to the neighbors.

FIG. 7 is a block diagram schematically illustrating an exemplary operator's terminal, which is connectable to a telecommunications network. The terminal comprises a data collecting unit 71 and a data analyzing unit 72, each unit provided with a suitable processor 74, 75. The terminal is configured to determine a churn risk value associated with a first UE by determining a direct weight factor for direct connections to the first UE, determining a linked weight factor for non-direct connections to the first UE, based on the direct weight factors, multiplying the determined weight factors with an initial churn value of the other UE, and determining a churn risk value for the first UE by adding said products to the initial churn value for the first UE.

The operator's terminal is further provided with a suitable communication unit 70 comprising a transmitter for sending an OUT-signal from the terminal, and a receiver for receiving an IN-signal to the terminal, and the communication unit is connected to the data collecting unit and to the data analyzing unit. The OUT-signal from the terminal contains information indicating which users that are likely to churn, and this information may be used by the operator in campaigns directed to those users. Further, this operator's terminal OUT-signal correspond to a signal out from the functional layer illustrated in box 42 in FIG. 4.

According to an exemplary embodiment, said data analysis unit 72 is configured to determine the direct weight factor as a function of one or more weight factor parameters associated with the connection, the parameters comprising call rate, SMS rate and call duration.

According to a still further embodiment, the terminal is configured to iterate the determining of a churn risk value in order to obtain an updated value for every time period of observation, setting the initial churn risk value to correspond to a churn risk value determined in a previous iteration.

According to a further exemplary embodiment, the terminal is configured to iterate a determined churn risk value at operator-defined time intervals, by re-calculating the initial churn risk values for each iteration, comparing the re-calculated initial churn risk value for the first UE with a previous initial churn risk value, and adjusting a determined churn risk value based on the comparison.

The data collecting unit 71 may interact with the communication unit 70 in order to be configured to generate and store call detail records for the operations of the UEs, comprising a memory unit 73, and the data analysis unit 72 may be configured to calculate an initial churn risk value for a UE by aggregating fields from the call detail records over a time interval, and determine a churn risk based on at least two different data processing models. The initial churn risk value is then calculated based on the average values of the said churn risks, and further based on the accuracy of each model.

The entities and units described above with reference to the figures are logical units, which do not necessarily correspond to separate physical units.

Furthermore, the above mentioned and described embodiments are only given as examples and should not be limiting to the present invention. Other solutions, uses, objectives, and functions within the scope of the invention as claimed in the accompanying patent claims should be apparent for the person skilled in the art.

### ABBREVIATIONS

CDR=Call Detail Record

CRS=Charging data Reporting System

CIM=Customer Information Management

GP=Genetic Programming

GA=Genetic Algorithm

1. A method for an operator's terminal in a telecommunication network of determining a churn risk value associated with a first User Equipment belonging to a group of operator-connected User Equipments, each User Equipment of the group associated with a calculated initial churn risk value, which depends on the usage, the method comprising:
determining a direct weight factor for direct connections between the first User Equipment and other User Equipments of the group;
determining a linked weight factor for non-direct connections between the first User Equipment and other User Equipments of the group, based on the direct weight factors of the connection;
calculating a weighted churn value for each of said direct and non-direct connections to the first User Equipment from the other User Equipments of the group, based on each determined weight factor and the initial churn risk value associated with the corresponding other User Equipment;
determining a churn risk value for the first User Equipment by adding each calculated weighted churn risk value to the initial churn risk value associated with the first User Equipment.

2. A method according to claim 1, wherein the determining of a direct weight factor for a direct connection to the first User Equipment is further based on one or more weight factor parameters, the parameters comprising call rate, SMS rate, and call duration.

3. A method according to claim 1, wherein the determining of a linked weight factor for a non-direct connection to the first User Equipment from another User Equipment comprises:
calculating a sum of the direct weight factors for each direct connection with said another User Equipment;
calculating the average value of the direct weight factors for each connection between the User Equipments directly connected to said another User Equipment and said first User Equipment;
determining a sum of the calculated average values, and
determining the linked weight factor by dividing the calculated sum of the direct weight factors with the sum of the calculated average values.

4. A method according to claim 1, wherein the calculation of a weighted churn risk value for each direct and non-direct connection to the first User Equipment from the other User Equipments of the group comprises multiplying each determined weight factor with the churn risk value associated with the corresponding other User Equipment.

5. A method comprising updating the determined churn risk value, by iterating the method according to claim 1 for every time period of observation, each iteration further comprising:
setting the initial churn risk value of said first User Equipment to correspond to a churn risk value determined in a previous iteration.

6. A method comprising iterating the method according to claim 1 with operator-defined time intervals, each iteration further comprising:
calculating initial churn risk values;
comparing the initial churn risk value for the first User Equipment with a previous initial churn risk value, and
adjusting a determined churn risk value based on the comparison.

7. A method according to claim 1, wherein a calculation of an initial churn risk value for a User Equipment comprises:
aggregating call detail records associated with the User Equipment over a time interval;
determining a churn risk for the User Equipment from the aggregated records, according to a hybrid approach, based on at least two different data processing models;
calculating the initial churn risk value for the User Equipment, based on the average values of the determined churn risks, and the accuracy of each data processing model.

8. A method according to claim 7, wherein said data processing models comprises a tree induction technique and a genetic algorithm.

9. A method for an operator's terminal in a telecommunication network of determining a churn risk value associated with more than one User Equipment belonging to a group of operator-connected User Equipments, the method comprising performing the method according to claim 1 for other User Equipments belonging to the group of User Equipments.

10. A method according to claim 1, wherein said group is formed based on the interaction between the User Equipments.

11. A method according to claim 1, wherein said group of User Equipments corresponds to a social network between the end-users of the User Equipments.

12. An operator's terminal connectable to a telecommunication network, the terminal comprising a communication unit, a data collecting unit and a data analyzing unit, each unit provided with a processing unit, wherein the terminal is configured to determine a churn risk value associated with a first User Equipment by:
determining a direct weight factor for direct connections between said first User Equipment and other User Equipments belonging to a group of operator-connected User Equipments, wherein each User Equipment of the group is associated with a pre-calculated initial churn risk value;
determining a linked weight factor for non-direct connections between said first User Equipment and the other User Equipments of the group, based on the determined direct weight factors of the connection;
calculating a weighted churn risk value for each of said direct and non-direct connections, based on each determined weight factor and a pre-calculated initial churn risk value associated with the corresponding other User Equipment, based on the usage;
determining a churn risk value for the first User Equipment by adding each calculated weighted churn risk value to the initial churn risk value associated with said first User Equipment.

13. An operator's terminal, according to claim 12, wherein the data analysis unit is configured to determine the direct weight factor for a direct connection to a first User Equipment by:
receiving the values of one or more weight factor parameters associated with the connection from the data collecting unit, the parameters comprising call rate, SMS rate and call duration, and
determining the direct weight factor for the connection based on the parameter values.

14. An operator's terminal, according to claim 12, the data analysis unit further being configured to determine a linked weight factor for a non-direct connection to a first User Equipment from another User Equipment of the group by:
calculating a sum of the direct weight factors for each direct connection with said another User Equipment;
calculating the average value of the direct weight factors for each connection between each User Equipment directly connected to said another User Equipment and said first User Equipment;
determining a sum of the calculated average values;
determining the linked weight factor by dividing the calculated sum of the direct weight factors with the sum of the calculated average values.

15. An operator's terminal, according to claim 12, the data analysis unit being configured to calculate a weighted churn value for a connection to a first User Equipment from another User Equipment by multiplying the determined weight factor for the connection with the churn risk value associated with said another User Equipment.

16. An operator's terminal, according to claim 12, further configured to iterate a determined churn risk value for every time period of observation, and for each iteration setting the initial churn risk value of said first User Equipment to correspond to a churn risk value determined in a previous iteration.

17. An operator's terminal, according to claim 12, further configured to iterate a determined churn risk value with operator-defined time intervals, and for each iteration:
calculating initial churn risk values;
comparing the initial churn risk value for the first User Equipment with a previous initial churn risk value, and
adjusting a determined churn risk value based on the comparison.

18. An operator's terminal according to claim 12, wherein the data collecting unit and the communication unit are configured to generate and store call detail records for the operations of the User Equipments in the group.

19. An operator's terminal, according to claim 12, wherein the data analysis unit is configured to calculate an initial churn risk value for a User Equipment by:
receiving call detail records from the data collecting unit;
aggregating the call detail records associated with the User Equipment over a time interval;
determining a churn risk for the User Equipment from the aggregated records, according to a hybrid approach, based on at least two different data processing models;
calculating the initial churn risk value for the User Equipment, based on the average values of the determined churn risks, and the accuracy of each data processing model.

20. An operator's terminal according to claim 12, configured to define a group of User Equipments, among User Equipments connected to the operator, based on the interaction between the User Equipments.
